(19) United States
(12) Patent Application Publication
(10) Pub. No.: US 2018/0239316 A1
(43) Pub. Date: Aug. 23, 2018

(54) COMMUNICATING WITH DEVICES

(71) Applicant: Google Inc., Mountain View, CA (US)

(72) Inventors: Robert Lopez Toscano, Mountain View, CA (US); Aparna Bhatnagar Sinha, Mountain View, CA (US); Igor Karp, Mountain View, CA (US); John Kozura, Mountain View, CA (US); Michael Fitzgerald Mester, Mountain View, CA (US)

(21) Appl. No.: 15/322,986

(22) PCT Filed: Nov. 12, 2015
(86) PCT No.: PCT/UA2015/000111

§ 371 Date: Dec. 29, 2016

(51) Int. Cl. G05B 15/02; G06F 9/451; G06F 8/38; G06F 3/0484

(52) U.S. Cl. CPC G05B 15/02; G06F 9/452; H04L 67/12; G06F 3/04847; G06F 8/38

(57) ABSTRACT

Methods, systems, and apparatus, including computer programs encoded on a computer storage medium, for sending a request, by a first computing device and for receipt by a second computing device, that the second computing device send data that describes characteristics of the second computing device. Receiving, from the second computing device, the data that describes the characteristics of the second computing device. Determining whether the second computing device includes the first component model based on the received data. Determining whether the second computing device includes the second component model based on the received data. Generating, by the first computing device, a graphical user interface that is associated with the second computing device.

### BACKGROUND

The Internet provides access to a wide variety of resources, such as image files, audio files, video files, and webpages. A search system can identify resources in response to queries submitted by users and provide information about the resources in a manner that is useful to the users. The users can navigate through, e.g., select, search results to acquire information of interest. Devices can sometimes communicate through the internet or through a local network. For example, a user may be able to control a thermostat through an application on his smartphone.

### SUMMARY

This specification relates to enabling a user to control multiple electronic devices, for example, devices that are a part of the Internet of Things (IoT), using a common interface.

In general, innovative aspects of the subject matter described in this specification can be embodied in methods that include actions of sending a request, by a first computing device and for receipt by a second computing device, that the second computing device send data that describes characteristics of the second computing device. Receiving, from the second computing device, the data that describes the characteristics of the second computing device, where data that describes the characteristics of the second computing device (i) identifies a first component model of the second computing device, (ii) identifies multiple traits of the first component model,(iii) identifies a second component model of the second computing device, and (iv) identifies multiple traits of the second component model. Determining whether the second computing device includes the first component model based on the received data. Determining whether the second computing device includes the second component model based on the received data. Generating, by the first computing device, a graphical user interface that is associated with the second computing device. And, the graphical user interface includes (i) a first graphical control to display or control one of the multiple traits of the first component, as a result of the first computing device having determined that the second computing device includes the first component, and (ii) a second graphical control to display or control one of the multiple traits of the second component, as a result of the first computing device having determined that the second computing device includes the second component. Other implementations of this aspect include corresponding systems, apparatus, and computer programs, configured to perform the actions of the methods, encoded on computer storage devices.

These and other implementations can each optionally include one or more of the following features. The multiple traits of the first component model can include multiple states of the first component model, commands for controlling the first component model, or a combination of both. The multiple traits of the second component model can include multiple states of the second component model, commands for controlling the second component model, or a combination of both.

In some implementations, the first computing device can generate the graphical control for controlling the one of the multiple traits of the first component model by determining whether the second computing device includes the first component model without determining whether the first component model includes the one of the multiple traits. The first computing device can store, before the first computing device received the data that describes the characteristics of the second computing device, information that identified the first component model as including the one of the multiple traits.

In some implementations, the data can identifies multiple traits of the second computing device, assigns the multiple traits of the first component model to the first component model, assigns the multiple traits of the second component model to the second component model, and assigns a first one of the multiple traits of the second computing device to the multiple traits of the first component model and a second one of the multiple traits of the second component model.

In some implementations, a first trait of the multiple traits of the second computing device is assigned to a second trait of the first component model, and a name of the first trait is different than a name of the second trait.

In some implementations, the method includes sending a command, to the second computing device, to change a state of a particular trait of the multiple traits of the second computing device by referencing a name of the first component model or the second component model to which the particular trait is mapped by the data.

In some implementations, the data identifies a trait of the second computing device and maps the trait of the second computing device to (i) one of the multiple traits of the first component model, and (ii) one of the multiple traits of the second component model that each refer to a same trait of the second computing device, due to the first component model and the second component model each having access to and sharing the same trait.

In some implementations, the data maps the multiple traits of the second component model to the second component model, identifies a third component model that represents an array of a plurality of the second component model without specifying a quantity of the second component model, and identifies at least two traits of the second computing device and maps the at least two traits to elements in the array of the plurality of the second component model.

In some implementations, the second computing device is an alarm clock, the first component model is a clock, and the second component model is an alarm. In some implementations, the second computing device is an oven, the first component model is an oven, and the second component model is light. In some implementations, the second computing device is a multi-light device the first component model is a light, and the second component model is an array of lights. In some implementations, the second computing device is a stove, the first component model is a first set of burners, and the second component model is a second set of burners. In some implementations, the second computing device is combined washer-dryer, the first component model is washer, and the second component model is dryer.

In some implementations, assigning the multiple traits of the second computing device to the multiple traits of the first component and the multiple traits of the second component includes assigning (i) a name of a first trait of the multiple traits of the second computing device to (ii) a name of a second trait of the first component, and the first name is different than the second name.

Implementations of the subject matter described in this specification can be implemented so as to realize one or more of the following advantages. Implementations may provide for efficient discovery of functions associated with an Internet of Things (IoT) capable device. Implementations may enable simple and precise synchronization of device states associated with an IoT capable device. Implementations may permit IoT capable device manufactures to add new functions (e.g., commands and states) to existing parts of devices and to permit discovery of new functions by computing device applications (e.g., apps). Implementations may permit disambiguation of duplicated functions for an IoT capable device, and permit apps to address commands to specific parts of the device for performing associated with the duplicated functions.

The details of one or more implementations of the subject matter of this disclosure are set forth in the accompanying drawings and the description below. Other features, aspects, and advantages of the subject matter will become apparent from the description, the drawings, and the claims.

### DESCRIPTION OF DRAWINGS

FIG. 1 depicts an example system in accordance with implementations of the present disclosure.

FIGS. 2A-2D depict exemplary component models and device definitions for exemplary IoT capable devices in accordance with implementations of the present disclosure.

FIG. 2E depicts exemplary GUIs for an IoT device interface application and an example of GUI rendering instructions.

FIG. 3 depicts an example process that can be executed in accordance with implementations of the present disclosure.

Like reference numbers and designations in the various drawings indicate like elements.

### DETAILED DESCRIPTION

There is tremendous diversity in the types of embedded devices that will be brought online by Internet of Things (IoT) technology. Due to the rise in IoT technology, a greater variety of traditionally non-computer based, devices and systems are being offered with internet connection capabilities. For example, devices and systems such as home appliances (e.g., refrigerators, stoves, ovens, microwaves, washers/dryers), building mechanical systems (e.g., heating ventilation and air conditioning (HVAC) systems), security systems (e.g., security cameras, locks), building electrical systems (e.g., lighting) can be embedded with computing systems enabling the monitoring and control of such systems and devices over the internet. The breadth of diversity of internet connected devices across various industries (e.g., home appliances to HVAC) and across different manufacturers presents a problem to both developers (e.g., application developers) and users. Without a standard process for efficiently identifying the functionality of IoT capable devices and communicating with IoT devices, developers may have difficulty integrating the functionality of unrelated devices (e.g., a user's HVAC system and refrigerator) into a single app. Consequently, users may have to use separate apps to control different IoT devices.

Implementations of the present disclosure are generally directed to enabling an integration of diverse types of embedded devices into IoT technology. More specifically, implementations provide a common device monitoring and control model (e.g., device model) for use by application developers and device manufacturers. The device model represents IoT devices and their corresponding functions based on device traits and component models. Device traits may represent the lowest composable units of functionality for IoT devices (e.g., “onOff,” “temperature,” “volume,” “brightness,” etc.). That is, device traits can represent specific device functions or device states. A trait can represent a function performable by a device and an associated command for controlling the function. For example, a trait of an IoT stove may be an individual burner. For example, the burner's function includes a range of settings from OFF through HIGH and associated command(s) for controlling the function (e.g., “burner.setTemperature()”). Similarly, a trait can also represent a state of a device such as, for example, a battery charge level and associated command(s) (e.g., “battery.getChargeLevel()”).

Component models represent groups of one or more traits combined into a common interface associated with a logical functionality between IoT device traits (e.g., “Security Camera,” “Light,” “Speaker,” “Display,” “Oven,” etc.). Component models may offer an abstraction over traits of the device that allows the device manufacturers to control what device functionality is exposed and how the functionality is exposed. A component model defines a collection of traits and the relationships between them. Traits of a particular device can be mapped to particular component models by the component models and a device definition. In addition, component models serve as a high level summary of the traits expressed by particular devices and provide a standardized syntax for communicating with IoT capable devices.

In some implementations, component models can include repeated traits (e.g. lights in a chandelier or speakers in a surround sound system). In some implementations, component models can include other component models. For example, a component model for a combination device (e.g., a combination washer/dryer) can include one or more component models associated with stand-alone devices (e.g., a separate washer or dryer). In some implementations, component models can be arranged in an inheritance model. For example, a component model for an improved device (e.g., a dimmable light lamp) can inherit traits (e.g., on/off) from a component model for a standard device (e.g., a standard lamp).

In some implementations, component models can be standardized to general device types (e.g., a stove, oven, lamp, stereo, security camera, thermostat, etc.). For example, such component models may not account for device functions which may or may not be available on a particular device of the same type (e.g., advanced functions or custom functions).

In some implementations, device manufacturers can provide custom device models that, for example, include functions of standard devices of the same type in addition to manufacturer or device specific functions (e.g., advanced functions).

In the examples described herein, the syntax “interface” is used to refer to component models when referring to examples of code. That is, the syntax “interface” can be used interchangeably with the term “component” or “component model” when referring to communications with, addressing for, or commands for IoT capable devices.

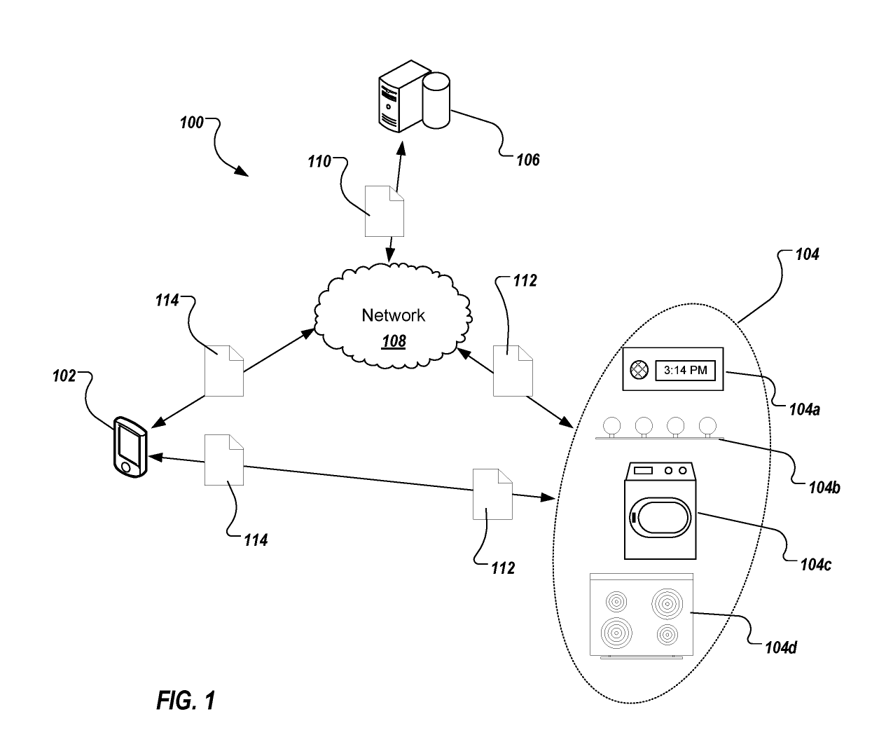

FIG. 1 depicts an example system 100 that can execute implementations of the present disclosure. The example system 100 includes a computing device 102 in communication with one or more IoT devices 104, and one or more server systems 106. The computing device 102 may be in communication with the IoT devices 104 and server systems 106 through network 108. The network 108 can include a large network or combination of networks, such as a local area network (LAN), wide area network (WAN), the Internet, analog or digital wired and wireless telephone networks (e.g., 4G and Long-Term Evolution (LTE) networks), a satellite network, one or more wireless access points, or any appropriate combination thereof connecting any number of mobile clients, fixed clients, and servers. In some implementations, the computing device 102 can also or alternatively communicate with the IoT devices 104 either directly through a wired or wireless interface (e.g., Universal Serial Bus (USB), Bluetooth, or Wi-Fi Direct).

The computing device 102 can be any of a number of different types of computing devices including, for example, a mobile phone; smartphone; personal digital assistant; laptop, tablet computer, or netbook computer; or a desktop computer. The computing device 102 typically can have internal or external storage components for storing data and programs such as an operating system and one or more application programs. In particular, the internal or external storage components for the computing device 102 to store a client application for interfacing with IoT devices 104. Additionally or alternatively, the computing device 102 can be configured to interface with IoT devices 104 without a specific user application, using, for example, a web browser.

Computing device 102 also includes a central processing unit (CPU) for executing instructions stored in storage and/or received from one or more other electronic devices, for example over network 108. Computing device 102 also includes one or more communication interfaces for sending and receiving data. Examples communication interfaces include antennas, transceivers, network communications cards, and other network adapters capable of transmitting and receiving data over a network (e.g., network 108) through a wired or wireless data pathway.

IoT devices 104 can be any internet capable device or system that can be controlled or monitored by, for example, an user application (e.g., an app) executed on a separate computing device (e.g., computing device 102). IoT devices can include, for example, an internet capable alarm clock 104a, multi-light fixture 104b, washer and dryer 104c, or stove 104d. An IoT device 104 includes a central processing unit (CPU) for executing instructions stored in storage and/or received from one or more other computing devices 102, for example over network 108. An IoT device 104 also includes one or more communication interfaces for sending and receiving data. Example communication interfaces include antennas, transceivers, network communications cards, and other network adapters capable of transmitting and receiving data over a network (e.g., network 108) through a wired or wireless data pathway.

The server systems 106 can be implemented using one or more computing devices (e.g., servers or a computing system). The one or more computing devices on which the server systems 106 are implemented can have internal or external storage components storing data and programs such as an operating system and one or more application programs. The one or more application programs can be implemented as instructions that are stored in the storage components and that, when executed, cause the one or more computing devices to provide the features ascribed herein to the server systems 106. Furthermore, the one or more computing devices on which each of the server systems 106 are implemented can include one or more processors for executing instructions stored in storage and/or received from one or more other electronic devices, for example, over network 108. In addition, these computing devices can include network interfaces and communication devices for sending and receiving data.

For example, the server systems 106 can be configured to store IoT device apps and/or IoT device data that can be accessed (e.g., downloaded) by computing device 102. For example, the server system can be an online store for purchasing computing device apps (e.g., an ANDROID application marketplace). In addition, the server system 106 can provide a library of standard IoT device models, IoT device component models, and device traits. The server systems 106 can be IoT device manufacturers' server systems that provide computing devices 102 with access to manufacturer specific IoT device models and/or component models associated with the manufacturers' IoT devices (e.g., a household appliance manufacturer's custom models for its IoT devices).

For example, a user may download an IoT device interface app 110 to a computing device 102 from a server system 106. The user may own an IoT capable alarm clock 104a made by manufacturer A, an IoT capable multi-light fixture 104b made by manufacturer B, an IoT capable washer and dryer 104c made by manufacturer C, and an IoT capable stove 104d made by manufacturer D. The IoT device interface app 110 can obtain device characteristic data associated with each of the user's IoT capable devices 104a-104d to generate appropriate user interfaces (e.g., graphical user interfaces (GUI)) for controlling each IoT capable device 104a-104d. For example, the IoT capable stove 104d, can send characteristic data 112 to the computing device 102. Characteristic data 112 can include data identifying one or more stove component models supported by the stove 104d (e.g., names of the supported component models). These component models may represent sub-portions of the device, and may be designated by a standard or may be designated by the manufacturer. For example, the stove 104d may support a standard stove component model (e.g., “FourBurnerStoveInterface”) and a manufacturer specific stove component model (e.g., “AdvancedStoveInterface”). In some examples, the characteristic data 112 can include data describing the supported component models. The data can identify multiple device traits that are associated with one or more of the supported component models. For example, the standard stove component model may include four burner traits, whereas the manufacturer specific stove component model may include four burner traits plus a corn roaster trait. In other words, as described in more detail below, the characteristic data 112 can include the component models themselves.

The computing device 102 can use the characteristic data 112 to determine which of the stove component models the IoT capable stove 104d supports and therefore may use the characteristic data 112 to generate an appropriate GUI for the user to control and monitor the status of the stove 104d. For example, the computing device 102 can access an appropriate component model that identifies specific device traits and that is associated with the component models supported by the stove 104d. The IoT interface app 110 can use the component model to determine, for example, attributes of a GUI for controlling the stove 104d, such as, the type of graphical controls to render (e.g., selection boxes, drop down menus, slider bars, etc.). A user can use the GUI on the computing device 102 to control the functions of the IoT capable stove 104d. For example, upon receiving a user input to a GUI, the IoT device interface app 110 can generate appropriate command data 114. The computing device 102 can send the command data 114 to the stove 104d to control, for example, the temperature of one of the burners on the stove 104d.

In some examples, the IoT device interface app 110 can include data defining various IoT device component models. For example, standard component models can be integrated into the device interface app 110 at a time that the app 110 is downloaded from the server system 106, or can be or downloaded from an IoT device library at the server system 106 at a later time. In some examples, the computing device 102 and app 110 can access IoT device model definitions from a manufacturer's server system (e.g., a manufacturer specific device model) or from an IoT device 104 (e.g., a component model may be included in the characteristic data 112).

In some examples, if the IoT device interface app 110 is unable to access data defining a particular component model, for example, a manufacturer specific model (e.g., “AdvancedStoveInterface”), the IoT device interface app 110 can still control the particular IoT capable device using a standard component model (e.g., “FourBurnerStoveInterface”). In other words, in some examples, IoT devices may be required to support standard component models in addition to any manufacturer or device specific component models.

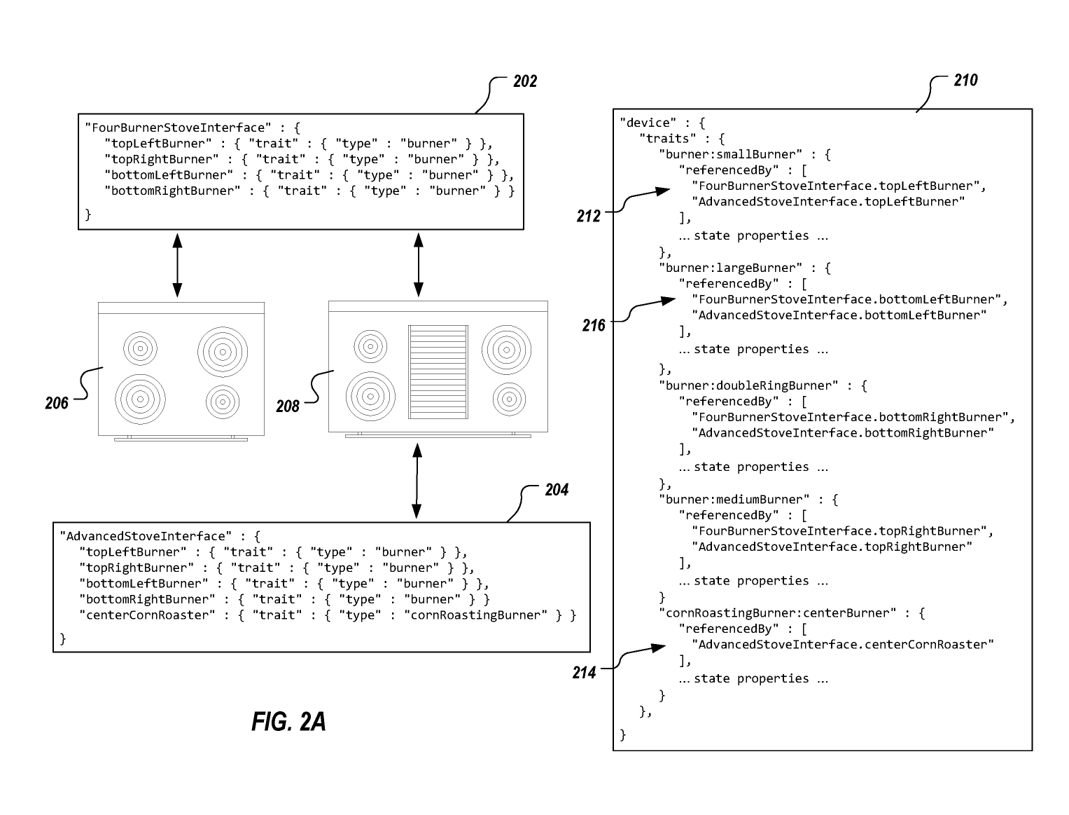

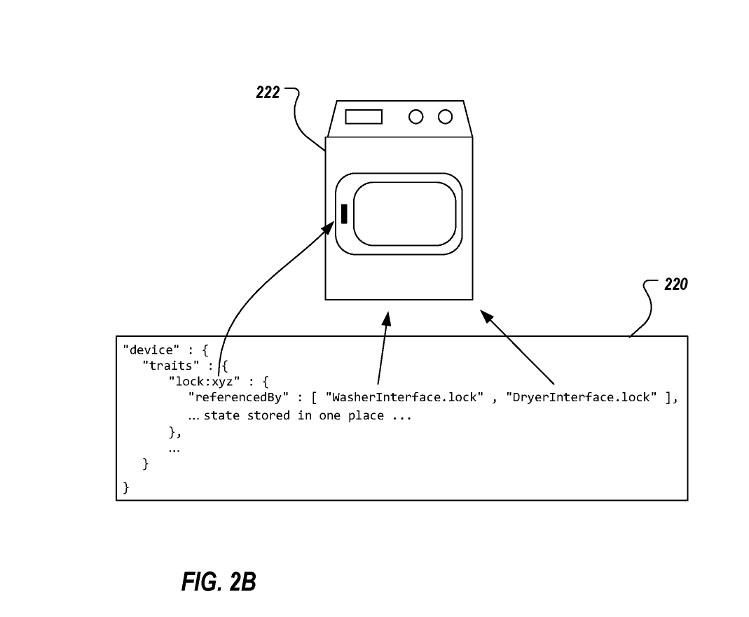

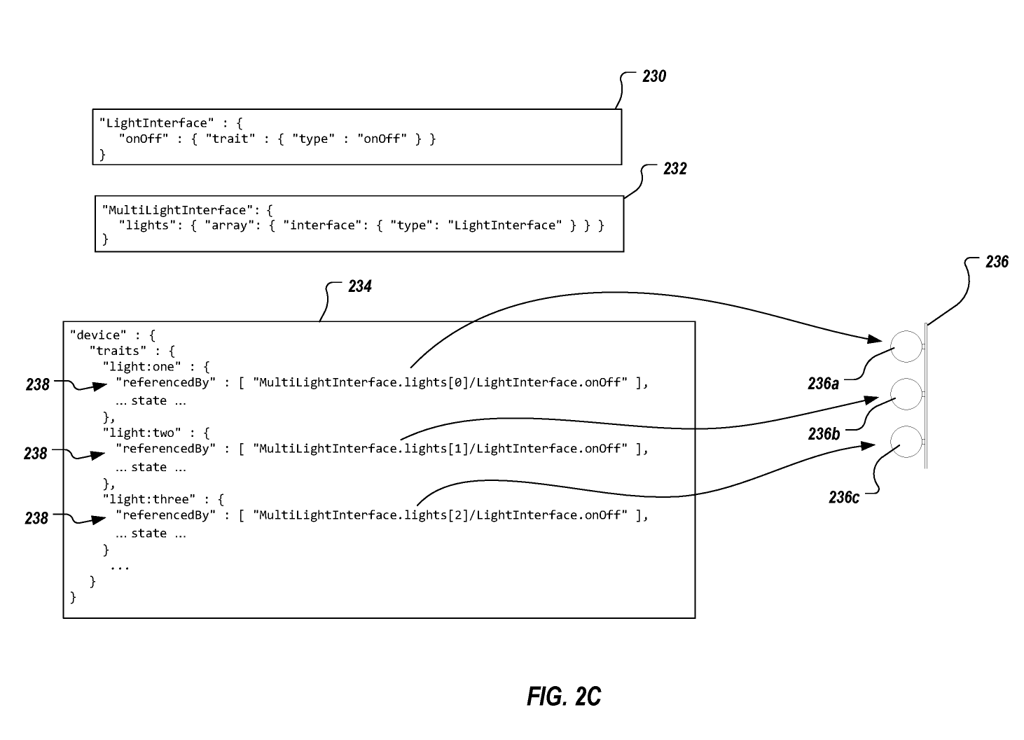

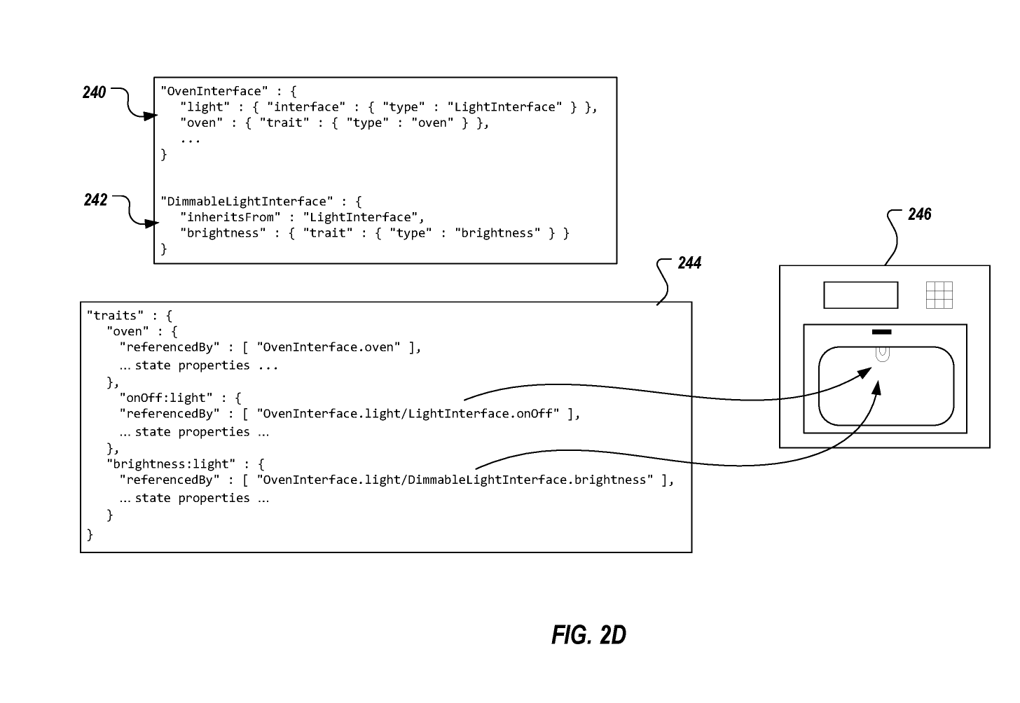

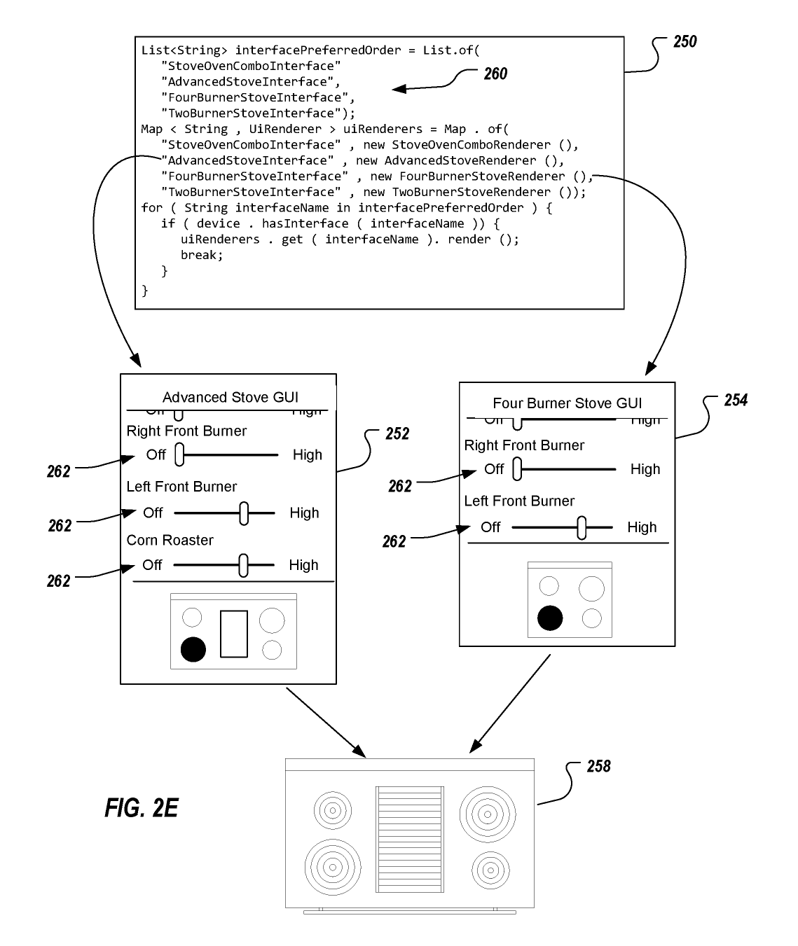

FIG. 2A depicts exemplary component models 202, 204 for exemplary IoT capable stoves 206, 208. Component models 202, 204 serve as a high level summaries of the traits expressed by stoves 206, 208 and provide a standardized syntax for communicating with the IoT capable stoves 206, 208. Each component models 202, 204 identifies traits supported by the component model and associates the supported traits to corresponding traits exposed by a particular IoT capable device. For example, component model 202 is for a standard component model (e.g., “FourBurnerStoveInterface”) and component model 204 is for a manufacturer defined component model (e.g., “AdvancedStoveInterface”). A standard stove 206 can include four “burner” traits while the advanced stove 208 includes four “burner” trait types and a “cornRoastingBurner” traits type. The standard stove 206 can be controlled only using component model 202 (of the two example component models shown) because it does not include all of the traits expressed in the component model 204. The advanced stove 208 can be controlled using either component model 202 or component model 204 because the advanced stove includes both “burner” and “cornRoastingBurner” traits.

Furthermore, the component models 202, 204 provide descriptive trait names (e.g., “topLeftBurner,” “topRightBurner,” “bottomLeftBurner,” and “bottomRightBurner”) usable by IoT device apps to address commands to a particular one of multiple similar traits in a single device. For instance, a separate “burner” trait is associated with each of the descriptive trait names (e.g., “topLeftBurner,” “topRightBurner,” “bottomLeftBurner,” and “bottomRightBurner”) of the component models 202, 204. In addition, a “cornRoastingBurner” trait is associated with the “centerCornRoaster” of the “AdvancedStoveInterface” component model 204.

Furthermore, a device maker must specify the mapping between traits of the component models, and traits exposed by the device. This is accomplished through a device definition 210. A device definition 210 specifies, for each trait of a particular device, which component models can be used to reference the trait. The example device definition 210 for the advanced stove 208 provides a detailed mapping between specific traits expressed by the advanced stove 208 and component models 202, 204 that may be called by an IoT device interface app to control functions of the advanced stove 208. Furthermore, in some examples, the device definition 210 can serve as a syntax translation between a standardized syntax used by IoT device interface apps, and a syntax used by an IoT device itself. The device definition 210 lists all of the traits expressed by the advanced stove 208 (e.g., four burners and a corn roaster). For each trait of the advanced stove 208, the device definition 210 specifies each component model that can reference the trait. For example, the first burner trait 212 can be referenced by either the “FourBurnerStoveInterface” component model 202 or the “AdvancedStoveInterface” component model 204. More specifically the first burner trait 212 can be referenced by the “topLeftBurner” trait of either the “FourBurnerStoveInterface” component model 202 or the “AdvancedStoveInterface” component model 204. The corn roasting burner trait 214, however, can only be referenced by the “AdvancedStoveInterface” component model 204.

Furthermore, in order to support devices which may keep track of multiple traits of the same type (e.g. four burners of a stove), traits can be identified by not only their type, but also with an optional device manufacturer provided name or trait suffix. This optional custom name can be referenced as a suffix to the trait type separated by a colon. For example, the first burner trait 212 is identified as the “smallBurner” while the second burner trait 216 is identified as the “largeBurner” in the advanced stove device definition 210. The custom name need not have any semantic relationship to the component models used by the device.

Additionally, the names used in an IoT device interface app need not conform to the custom names used by a device manufacturer. For example, an IoT device interface app can issue a command to set the temperature of the burner trait associated with the “smallBurner” of the advanced stove 208 by referencing the component model name associated with the “smallBurner” (e.g., “topLeftBurner”) instead of referencing the manufacturer's custom name associated with a specific burner. For example, a command to set the temperature of the top left burner of an advanced stove named “stove1” may be formatted as:

stove1.topLeftBurner.setTemperature(HIGH);

Thus, the use of component models may be advantageous in allowing apps to be compatible with IoT capable devices manufactured by many different manufacturers while allowing each manufacturer to use different custom naming conventions.

In some implementations, the device definition 210 can be included in the device characteristic data provided from the IoT device (e.g., device 104a) to a computing device (e.g., computing device 102).

In some examples, component models can be used in an alternative fashion, as described above in reference to the standard four burner stove component model 202 and the advanced stove component model 204. That is, an IoT device interface app can select one of the two component models 202, 204 to use for generating a GUI to control the advanced stove 208, but would generally not use both. However, when a particular IoT capable device is a combination of two devices (e.g. a combination washer/dryer) the concurrent use of two different component models may be required to control a single IoT capable device, or even a single trait of an IoT capable device.

For example, FIG. 2B depicts an exemplary device definition 220 for exemplary IoT capable washer-dryer-combo device 222. The washer-dryer-combo device which uses a single lock for both the washer and the dryer. Furthermore, a single lock trait (“lock:xyz”) is referenced by both a “WasherInterface” component model and a “DryerIntreface” component model. In such situations, the component models allow a device manufacturer to share traits between multiple interfaces and maintain synchronization of the shared trait across component models. For example, by using component models to reference device functions, the device definition 220 for the washer-dryer-combo device 222 may only define a single lock trait that can be referenced by both the “WasherInterface” component model and the “DryerInterface” component model. Therefore, the state (e.g., locked/unlocked) of the shared lock can be stored in a single variable, thereby, eliminating the need to synchronize separate lock variables for each interface of the combined device (e.g., washer and dryer) that are associated with a single lock on the device.

In some implementations, component models can represent an IoT capable device with multiple traits of the same type where the number of the multiple same type traits is unspecified. For example, as shown in FIG. 2C, component models can incorporate an array of traits or an array of other component models to represent an unspecified number of the same type of traits. FIG. 2C depicts exemplary component models for a light (light component model 230) and a multi-light device (multi-light component model 232), an IoT capable multi-light fixture 236, and a device definition 234 for the multi-light fixture 236. The multi-light component model 232 includes an unbounded array of light component models 230. As such, the multi-light component model may be used as a standard type of component model for any multi-light lighting device irrespective of the actual number of light traits included in the device. For example, the multi-light component model could be used for IoT capable chandeliers, track lighting, string lights, etc. Moreover, similar multi-trait or multi-component model arrays can be generated for other types of multiple traits (e.g., an unspecified number of stove burners).

Furthermore, the device definition 234 provides an example of how a trait or component model array can be implemented for a specific device. For example, the device definition 234 for the multi-light fixture 236 exposes the three traits 238 associated with the three lights of the multi-light fixture 236. Each light trait 238 includes an optional custom name (e.g., “one,” “two,” and “three”) to differentiate the light traits within the device itself, and a reference to an array index of the array of light component models 230 defined by the multi-light component model 232. Each light trait 238 can be used to control one of the lights (236a, 236b, 236c) of the multi-light fixture 236. Further, by using the array, an IoT device interface app can interface with any multi-light device, for example, and without requiring information regarding the actual number of lights in the device. For example, when a trait is referenced by a component model that defines an array of traits or component models, the trait can be referenced by an array index instead of a specific name. This allows a manufacturer to provide specific descriptive names to each trait, while, at the same time, permitting an app to address the same traits through an array.

In some implementations, when a trait is referenced by a component model that includes another component model, then the reference should be scoped appropriately. For example, the reference can first identify the property of the top level component model that the trait is indirectly referenced by (e.g., the multi-light component model “MultiLightInterface.lights[0]”), followed by a delimiter (e.g., “I”), followed by the included component model (e.g., the light component model 230 “LightInterface”) directly referencing the trait (e.g., the “onOff” trait of the light component model 230).

In some implementations, component models can use inheritance to add an advanced trait with additional functionality to a basic trait. For example, as shown in FIG. 2D, component models can inherit basic traits and add additional traits to provide additional functionality to an IoT capable device. FIG. 2C depicts an oven component model 240 including a basic light component model (“LightInterface”), an advanced dimmable light component model 242, and a device definition 244 for an IoT capable oven 246. For example, the basic light component model may be insufficient to control a dimmable light feature of an IoT capable oven 246. A “brightness” trait can be added to the basic light component model using inheritance. For example, the dimmable light component model 242 can be defined to inherit all of the traits of a basic light component model (e.g., an “onOff” trait) and add a “brightness” trait for controlling a dimmable light bulb.

For example, the oven component model 240 includes a basic light component model (“LightInterface”) and an oven trait (“oven”). The oven component model 240 may be sufficient for most IoT capable ovens, but when considering an oven that has the ability to dim a light. The dimmable light component model 242 provides a relationship between the basic light component model and the “brightness” trait in order for an app to access light dimming capability of the IoT capable oven's 246 light. Furthermore, the device definition 244 illustrates three traits of the IoT capable oven 246 that are referenced by the oven component model 240. The “onOff” and “brightness” traits are both referenced by the “OvenInterface.light” trait of the oven component model 240, but they are referenced by different sub-component models. Specifically, the “onOff” trait is referenced by the basic light component model (“LightInterface”), and the “brightness” trait is referenced by the dimmable light component model 242 (“DimableLightInterface”); both of which are sub-component models of the oven component model 240.

In some examples, interfaces can provide a clear and static mechanism for app developers to generate an IoT device interface app capable of interacting with IoT capable devices which is independent from the software models that the devices use to model device states. For example, a computing device can query an IoT capable device for a set of component models that the IoT capable device incorporates in its device definition, including any custom component models (e.g., the device characteristic data discussed above).

In some implementations, component models are statically defined and can be represented by software libraries that can be linked to an app. Therefore, discovery of the component models supported by a particular IoT capable device can be accomplished by querying the device, as discussed above in reference to FIG. 1. Since the variance in IoT capable devices can be expressed by supported component models (e.g., the presence or absence of supported component models), GUIs can be rendered more efficiently in IoT device interface apps.

For example, FIG. 2E shows GUIs 252, 254 rendered for an IoT device interface app and example GUI rendering instructions 250. The app can include a preferential GUI rendering order 260 based on a successive presence of more advanced component models. The IoT device interface app can compare a list of component models supported by a particular IoT capable device (e.g., IoT capable stove 258) and render a GUI that is customized to a selected component model supported by both the app and the device. For example, if both the app and the IoT capable stove support the “AdvancedStoveInterface” component model then the app can render GUI 252, which provides slider controls 262 for four burners plus a corn roaster. If either the app or the IoT capable stove 258 does not support the “AdvancedStoveInterface” component model, then the app can render a GUI 254 associated with another commonly supported, but, for example, less advanced component model (e.g., a “FourBurnerStoveInterface” component model). Thus, GUI 254 may only have slider controls 262 for controlling four burners of the IoT capable stove 258, but not the corn roaster.

In some implementations, all that needs to be communicated from an IoT device to a computing device (e.g., in the device characteristic data) for an app to render an appropriate GUI is the name of the component models supported by a device instead of the device's entire definition. In some implementations, a GUI can include multiple different screens that are shown at different times, for example, as a result of a user providing input to switch from one screen to the next.

In some implementations, an IoT device interface app can generate a generic GUI for an IoT capable device based on a device definition, for example, if a particular component model is not recognized by the IoT device interface app. For example, an IoT interface app can map different traits included in a device definition to appropriate attributes of a GUI. For example, a Boolean trait (e.g., “onOff”) can be represented and controlled by a check box in the GUI, a trait with an integer range (e.g., “brightness”) can be represented and controlled by a slider bar in the GUI, and a trait having an enumerated variable (e.g., a “burner” trait's settings (OFF, LOW, MED, HIGH)) can be represented and controlled by a dropdown menu in the GUI.

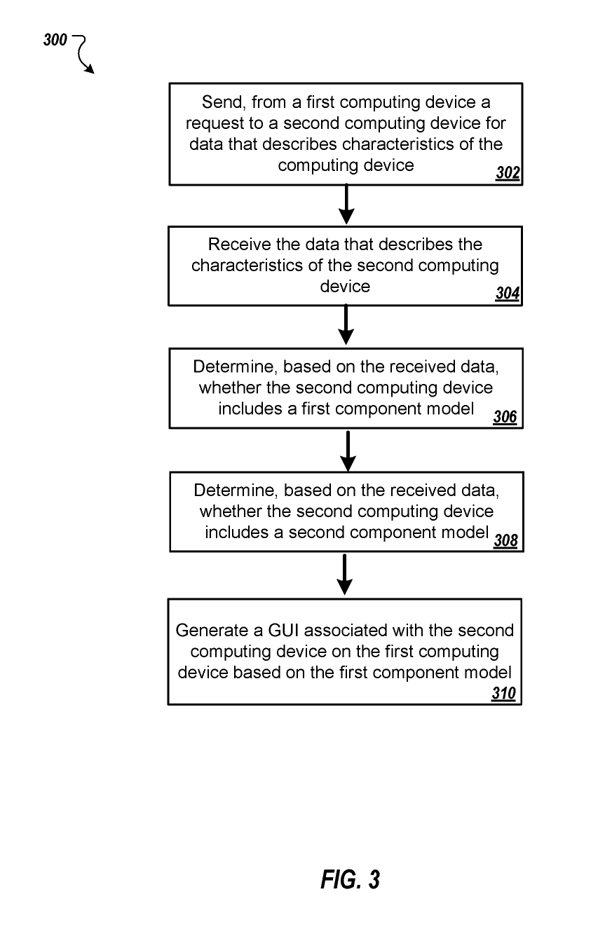

FIG. 3 depicts an example process 300 that can be executed in accordance with implementations of the present disclosure. In some examples, the example process 300 can be provided as one or more computer-executable programs executed using one or more computing devices. In some examples, the process 300 is a computing device executing an IoT device interface app.

A first computing device sends a request to a second computing device for data that describes characteristics of the second computing device (302). The first computing device receives the data that describes the characteristics of the second computing device from the second computing device (304). For example, the data can include data that identifies a first component model of the second computing device, data that identifies multiple traits of the first component model, data that identifies a second component model of the second computing device, and data that identifies multiple traits of the second component model. For example, as described above in reference to FIG. 1, the first computing device can request device characteristic data from an IoT capable device. Characteristic data can include, for example, data identifying one or more component models supported by an IoT capable device. The characteristic data can include only names of the supported component models. The characteristic data can include the component models themselves (e.g., as described above in reference to FIG. 2A). In some implementations, the characteristic data can include a device definition associated with the second computing device, where the device definition identifies the traits of the device and relates the traits to the devices' supported component models (e.g., as described above in reference to FIG. 2A).

The first computing device determines, based on the received data, whether the second computing device includes the first component model (306). The first computing device determines based on the received data, whether the second computing device includes the second component model (308). For example, the first computing device can determine based on characteristic data for the second computing device whether the second computing device includes the first and second component models. For example, first computing device can identify from a list of component models supported by the second computing device whether the second computing device supports the first and/or the second computing model by identifying the first and/or the second computing model in the list.

The first computing device generates a graphical user interface (GUI) that is associated with the second computing device based on the first component model (310). For example, as discussed in reference to FIG. 2E, as a result of the first computing device having determined that the second computing device includes the first component model the first computing device can generate a GUI that includes graphical controls to display or control one of multiple traits associated with the first component model. For example, the first computing device can determine that the second computing device supports only one of the first and second component models and generate a GUI based on only the supported component model. In some examples, the first computing device may determine that both of the first and second component models are supported by the second computing device. In such implementations, the first computing device can select one of the supported component models and generate a GUI based on the selected component model. For example, the first computing device can select between the first and the second component models based on an order of preference among multiple component models.

Further to the descriptions above, in situations in which the systems discussed herein collect personal information about users, or may make use of personal information, a user may be provided with controls allowing the user to make an election as to both if and when systems, programs or features described herein may enable collection of user information (e.g., a user's preferences, a user's IoT capable devices, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

Implementations of the subject matter and the operations described in this specification can be realized in digital electronic circuitry, or in computer software, firmware, or hardware, including the structures disclosed in this specification and their structural equivalents, or in combinations of one or more of them. Implementations of the subject matter described in this specification can be realized using one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. Elements of a computer can include a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending webpages to a web browser on a user's client device in response to requests received from the web browser.

Implementations of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any implementation of the present disclosure or of what may be claimed, but rather as descriptions of features specific to example implementations. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method executed by a computing device, the method comprising:
sending, by a first computing device and for receipt by a second computing device, a request that the second computing device send data that describes characteristics of the second computing device;
receiving, at the first computing device from the second computing device, the data that describes the characteristics of the second computing device, wherein the data:
(i) identifies a first component model of the second computing device,
(ii) identifies multiple traits of the first component model,
(iii) identifies a second component model of the second computing device, and
(iv) identifies multiple traits of the second component model;
determining, by the first computing device and based on the received data, whether the second computing device includes the first component model;
determining, by the first computing device and based on the received data, whether the second computing device includes the second component model; and
generating, by the first computing device, a graphical user interface that is associated with the second computing device and that includes:
(i) a first graphical control to display or control one of the multiple traits of the first component, as a result of the first computing device having determined that the second computing device includes the first component, and
(ii) a second graphical control to display or control one of the multiple traits of the second component, as a result of the first computing device having determined that the second computing device includes the second component.

2. (canceled)

3. The computer-implemented method of claim 1, wherein:
the first computing device generated the graphical control for controlling the one of the multiple traits of the first component model by determining whether the second computing device includes the first component model without determining whether the first component model includes the one of the multiple traits; and
the first computing device stored, before the first computing device received the data that describes the characteristics of the second computing device, information that identified the first component model as including the one of the multiple traits.

4. The computer-implemented method of claim 1, wherein the data:
identifies multiple traits of the second computing device
assigns the multiple traits of the first component model to the first component model,
assigns the multiple traits of the second component model to the second component model, and
assigns a first one of the multiple traits of the second computing device to the multiple traits of the first component model and a second one of the multiple traits of the second component model.

5. (canceled)

6. The computer-implemented method of claim 4, further comprising:
sending, by the first computing device and for receipt by the second computing device, a command to change a state of a particular trait of the multiple traits of the second computing device by referencing a name of the first component model or the second component model to which the particular trait is mapped by the data.

7. The computer-implemented method of claim 1, wherein:
the data identifies a trait of the second computing device and maps the trait of the second computing device to (i) one of the multiple traits of the first component model, and (ii) one of the multiple traits of the second component model that each refer to a same trait of the second computing device, due to the first component model and the second component model each having access to and sharing the same trait. (Original) The computer-implemented method of claim 1, wherein the data:
maps the multiple traits of the second component model to the second component model,
identifies a third component model that represents an array of a plurality of the second component model without specifying a quantity of the second component model, and
identifies at least two traits of the second computing device and maps the at least two traits to elements in the array of the plurality of the second component model.

9. The computer-implemented method of claim 2, wherein:
the second computing device is an alarm clock, the first component model is a clock, and the second component model is an alarm, or
the second computing device is an oven, the first component model is an oven, and the second component model is light or
the second computing device is a multi-light device the first component model is a light, and the second component model is an array of lights, or
the second computing device is a stove, the first component model is a first set of burners, and the second component model is a second set of burners, or
the second computing device is combined washer-dryer, the first component model is washer, and the second component model is dryer.

10. The computer-implemented method of claim 4, wherein:
assigning the multiple traits of the second computing device to the multiple traits of the first component and the multiple traits of the second component includes assigning (i) a name of a first trait of the multiple traits of the second computing device to (ii) a name of a second trait of
the first component, and the first name is different than the second name.

11. A system comprising:
at least one processor; and
a data store coupled to the one or more processors having instructions stored thereon which, when executed by the at least one processor, causes the one or more processors to perform operations comprising:
sending, by a first computing device and for receipt by a second computing device, a request that the second computing device send data that describes characteristics of the second computing device;
receiving, at the first computing device from the second computing device, the data that describes the characteristics of the second computing device, wherein the data:
(i) identifies a first component model of the second computing device,
(ii) identifies multiple traits of the first component model,
(iii) identifies a second component model of the second computing device, and
(iv) identifies multiple traits of the second component model;
determining, by the first computing device and based on the received data, whether the second computing device includes the first component model;
determining, by the first computing device and based on the received data, whether the second computing device includes the second component model; and
generating, by the first computing device, a graphical user interface that is associated with the second computing device and that includes:
(i) a first graphical control to display or control one of the multiple traits of the first component, as a result of the first computing device having determined that the second computing device includes the first component, and
(ii) a second graphical control to display or control one of the multiple traits of the second component, as a result of the first computing device having determined that the second computing device includes the second component.

12. (canceled)

13. The system of claim 11, wherein:
the first computing device generated the graphical control for controlling the one of the multiple traits of the first component model by determining whether the second computing device includes the first component model without determining whether the first component model includes the one of the multiple traits; and
the first computing device stored, before the first computing device received the data that describes the characteristics of the second computing device, information that identified the first component model as including the one of the multiple traits.

14. The system of claim 11, wherein the data:
identifies multiple traits of the second computing device
assigns the multiple traits of the first component model to the first component model,
assigns the multiple traits of the second component model to the second component model, and
assigns a first one of the multiple traits of the second computing device to the multiple traits of the first component model and a second one of the multiple traits of the second component model.

15. The system of claim 14, wherein:
a first trait of the multiple traits of the second computing device is assigned to a second trait of the first component model, and
a name of the first trait is different than a name of the second trait.

16. The system of claim 14, further comprising:
sending, by the first computing device and for receipt by the second computing device, a command to change a state of a particular trait of the multiple traits of the second computing device by referencing a name of the first component model or the second component model to which the particular trait is mapped by the data.

17. The system of claim 11, wherein:
the data identifies a trait of the second computing device and maps the trait of the second computing device to (i) one of the multiple traits of the first component model, and (ii) one of the multiple traits of the second component model that each refer to a same trait of the second computing device, due to the first component model and the second component model each having access to and sharing the same trait.

18. The system of claim 11, wherein the data:
maps the multiple traits of the second component model to the second component model,
identifies a third component model that represents an array of a plurality of the second component model without specifying a quantity of the second component model, and
identifies at least two traits of the second computing device and maps the at least two traits to elements in the array of the plurality of the second component model.

19. The system of claim 12, wherein:
the second computing device is an alarm clock, the first component model is a clock, and the second component model is an alarm, or
the second computing device is an oven, the first component model is an oven, and the second component model is light or
the second computing device is a multi-light device the first component model is a light, and the second component model is an array of lights, or
the second computing device is a stove, the first component model is a first set of burners, and the second component model is a second set of burners, or
the second computing device is combined washer-dryer, the first component model is washer, and the second component model is dryer.

20. The system of claim 14, wherein:
assigning the multiple traits of the second computing device to the multiple traits of the first component and the multiple traits of the second component includes assigning (i) a name of a first trait of the multiple traits of the second computing device to (ii) a name of a second trait of the first component, and
the first name is different than the second name.

21. The computer-implemented method of claim 1, wherein the first component model inherits at least one trait from a third component model and wherein the first component model defines at least one trait that is not included in the third component model.

22. The computer-implemented method of claim 1, wherein the second computing device comprises a first component represented by the first component model and a second component represented by the second component model;
wherein a trait of the multiple traits of the first component model is a shared trait that is also included in the multiple traits of the second component model; and
Wherein the shared trait is a command for controlling a function that can be performed by both the first component and the second component of the second computing device.

23. The system of claim 11, wherein the first component model inherits at least one trait from a third component model and wherein the first component model defines at least one trait that is not included in the third component model.
